(19) United States
(12) Patent Application Publication
(10) Pub. No.: US 2026/0330329 A1
(43) Pub. Date: Oct. 22, 2026

(54) SYSTEM AND METHOD FOR VERIFYING OFFLINE RETAIL INFORMATION USING MULTI-SIGNAL TRUST INTELLIGENCE

(71) Applicant: Pinaki Ranjan Bhattacharyya, REGINA (CA)

(72) Inventor: Pinaki Ranjan Bhattacharyya, REGINA (CA)

(21) Appl. No.: 19/692,958

(22) Filed: May 29, 2026

(51) Int. Cl. G06N 20/10; G06N 3/02; G06N 7/01; G06V 10/74; G06V 20/00; G06V 30/10

(52) U.S. Cl. CPC G06N 20/10; G06N 3/02; G06N 7/01; G06V 10/761; G06V 20/95; G06V 30/10

(57) ABSTRACT

A system and method for validating user-submitted transaction data from offline retail environments. The system receives images of receipts, price tags, or promotional materials with associated metadata including location and timestamps. The system validates data through multi-dimensional verification including metadata extraction and validation, image authenticity assessment through reuse detection and freshness evaluation, geo-temporal validation assessing location accuracy and proximity to known retail locations, optical character recognition with text integrity assessment, and behavioral and market plausibility analysis comparing extracted prices against historical data and detecting outliers. A composite confidence score is computed by aggregating confidence values from multiple independent verification dimensions. Advanced artificial intelligence processing is conditionally invoked based on confidence thresholds, enabling cost-controlled orchestration. Validated information is presented with confidence indicators through a user interface that receives confirmations or corrections, with user feedback incorporated into ongoing trust assessment to improve validation accuracy over time.

### FIELD OF THE INVENTION

The present invention relates to data validation systems and methods, and more particularly, to systems and methods for authenticating, validating, and processing user-submitted transaction data, including images and associated metadata, through multi-dimensional verification mechanisms with adaptive confidence scoring and conditional processing orchestration.

### BACKGROUND OF THE INVENTION

In modern commerce, there exists an increasing need to collect, validate, and aggregate retail pricing information, promotional offers, and transaction data from physical offline retail environments. Unlike e-commerce platforms where product prices, availability, and promotional offers are digitally accessible through structured databases and application programming interfaces, information about offline retail transactions exists primarily in physical form as printed receipts, shelf price tags, promotional signage, and in-store displays.

Various systems have been developed to address different aspects of retail information capture, authentication, and validation. However, these prior art systems suffer from significant limitations when applied to user-generated content from offline retail environments.

Chinese Patent Application Publication No. CN119090568A discloses a store authenticity verification method that performs detection processing on shop images including shop front detection, moire detection, screenshot detection, and watermark detection. However, this reference focuses solely on verifying the authenticity of merchant storefronts and does not address validation of transaction-level retail information such as prices, promotions, or receipt data. The system lacks mechanisms for evaluating temporal consistency, market plausibility of pricing, or behavioral patterns across multiple user submissions.

U.S. Pat. No. 9,300,678 describes systems and methods for authenticating photographic image data by applying watermarks, date and time information, and location information to images. While this reference addresses image authenticity through metadata validation, it does not disclose extraction or validation of retail information content from images, nor does it provide mechanisms for evaluating the plausibility or accuracy of retail pricing data or promotional claims contained within photographs.

U.S. Pat. App. Publication No. US2025/0156881 discloses a merchant authenticity verification system based on street view image recognition. The system matches merchant storefront images against street view images to calculate similarity and performs character recognition to match merchant names. However, this approach is limited to verifying the existence and identity of physical merchant locations and does not address validation of transaction data, pricing information, or promotional offers claimed by users. The system relies on pre-existing street view databases captured by service providers rather than validating user-generated content.

U.S. Pat. App. Publication No. US2017/0039450 describes identifying entities to be investigated using storefront recognition through feature matching between source images and candidate images. Similar to the previous reference, this system focuses on merchant identification rather than transaction validation, and does not provide mechanisms for assessing the reliability or plausibility of retail information extracted from user-submitted images.

U.S. Pat. App. Publication No. US2010/0310182 discloses geocoding by image matching using Scale-Invariant Feature Transform (SIFT) to associate geographic locations with identities. While this reference addresses location-image correlation, it does not teach validation of retail transaction data or evaluation of extracted pricing and promotional information for consistency, plausibility, or authenticity.

Chinese Pat. App. Publication No. CN111832658A describes processing point-of-interest information by classifying door face images to determine business state. The system performs image classification to assess whether businesses are open or closed but does not extract or validate retail transaction information, pricing data, or promotional claims from user-submitted images.

Chinese Pat. App. Publication No. CN111083095A discloses a method for providing authentication data by capturing user-related objects with cameras. This general authentication framework does not specifically address offline retail information validation or provide mechanisms for multi-dimensional trust assessment of extracted retail data.

The prior art systems described above suffer from several critical deficiencies when applied to the problem of validating user-generated offline retail information:

Prior art systems typically apply one or at most two validation dimensions. For example, CN119090568A focuses solely on image authenticity through detection of screenshots and watermarks; and US2025/0156881A validates merchant identity through storefront matching but does not verify transaction details; No prior art system integrates multiple independent trust signal categories including image authenticity, geo-temporal consistency, text extraction integrity, and behavioral and market plausibility into a unified validation framework.

None of the cited prior art discloses or suggests validating extracted retail information by evaluating market-level plausibility. There is no teaching in the prior art of determining whether a claimed price materially deviates from historical or regional norms, whether a promotional discount is consistent with known store behavior patterns, or whether a user's contribution history affects confidence in current submissions. This dimension of validation moves beyond traditional image authenticity or optical character recognition accuracy and introduces context-aware reasoning over real-world retail dynamics.

Prior art systems either apply validation processing uniformly to all submissions regardless of initial confidence indicators, or do not address computational resource allocation at all. There is no teaching in the prior art of computing a composite confidence score from multiple verification dimensions and using this score to conditionally invoke advanced or computationally intensive artificial intelligence processing only when low confidence or ambiguity is detected. This cost-controlled orchestration approach, which applies deterministic or lightweight validation first and escalates to expensive advanced processing only when necessary, is not disclosed or suggested by the cited references.

While certain prior art references contemplate manual review in exceptional cases, none disclose integrating human confirmation as a systematic reinforcement mechanism where extracted information is presented alongside granular confidence indicators and user confirmation or correction feeds back into future trust evaluations. The prior art does not teach closed-loop trust learning systems that improve validation accuracy over time through structured incorporation of user feedback.

Many prior art systems implicitly rely on existing digital merchant databases, online listings, street view imagery captured by service providers, or point-of-sale data from merchant systems. For example, US2025/0156881A requires street view images from mapping services, and U.S. Pat. No. 11,489B1 operates on merchant inventory and transaction data from point-of-sale systems. These approaches are not designed for scenarios where user-captured images serve as the primary data source in the absence of authoritative digital records. The prior art does not address the specific technical challenge of validating offline retail information when no ground-truth reference data exists.

Several prior art systems such as U.S. 10,002,344B2 and U.S. Pat. No. 11,489B1 are designed for merchant-side deployment using dedicated in-store camera systems or merchant point-of-sale data. These systems do not contemplate validation of user-generated photographic evidence captured by ordinary consumers using mobile devices under uncontrolled conditions with variable image quality, lighting, perspective, and capture timing.

There is therefore a substantial and unmet need in the art for an improved system and method that can reliably validate user-generated offline retail information through multi-dimensional verification incorporating multiple independent trust signal categories. Such a system must be capable of assessing not only image authenticity and text extraction accuracy, but also geo-temporal consistency, behavioral patterns, and market plausibility of claimed prices and promotions.

There is a further need for a system that computes composite confidence scores from heterogeneous validation signals and uses these scores to orchestrate processing resources efficiently, invoking computationally intensive or expensive advanced processing only when confidence thresholds are not met or when ambiguity is detected. There is additionally a need for a system that integrates human confirmation as a systematic component of the validation pipeline, presenting confidence indicators alongside extracted information and incorporating user feedback into ongoing trust assessment to enable continuous improvement of validation accuracy.

There is also a need for a system specifically architected for offline, physical retail environments where user-captured images serve as the primary data source and authoritative digital reference data may be unavailable, requiring robust validation mechanisms that can operate independently of e-commerce platforms, online review systems, or comprehensive merchant databases. The present invention addresses these needs by providing a novel multi-signal trust-based verification architecture specifically configured for offline retail information validation, as will be described in detail hereinafter.

### BRIEF SUMMARY OF THE INVENTION

The present invention addresses the aforementioned needs by providing a system and method for multi-dimensional verification of user-submitted transaction data with adaptive confidence scoring and conditional processing orchestration.

In accordance with one aspect of the present invention, there is provided a method for validating user-submitted transaction data comprising: receiving submission data including at least one media file and associated metadata; extracting metadata attributes from the submission data; performing image authenticity assessment including reuse detection and freshness evaluation; executing geo-temporal validation logic based on location accuracy and temporal consistency; extracting textual information from the media file and performing integrity assessment; evaluating behavioral and market plausibility signals; computing a composite confidence score based on aggregation of validation results from multiple verification dimensions; conditionally invoking advanced processing modules based on the composite confidence score; and presenting validated data with confidence indicators to a user interface for confirmation or correction.

In accordance with another aspect of the present invention, there is provided a system for validating user-submitted transaction data comprising: a data ingestion module configured to receive media files and associated metadata; a metadata extraction module configured to parse and validate metadata attributes; an image authenticity module configured to perform reuse detection and freshness evaluation; a geo-temporal validation module configured to assess location and temporal consistency; an optical character recognition module configured to extract text from media files; a text integrity assessment module configured to validate extracted text structure and content; a market plausibility module configured to evaluate transaction data against historical patterns; a confidence scoring engine configured to compute composite confidence scores; an orchestration engine configured to conditionally invoke advanced processing based on confidence thresholds; and a user interface module configured to present validation results and receive user feedback.

Other aspects and advantages of the invention will become apparent from the following detailed description taken in conjunction with the accompanying drawings.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating principles of the invention.

FIG. 1 is a system architecture diagram illustrating a system architecture for multi-dimensional verification of user-submitted transaction data in accordance with an embodiment of the present invention.

FIG. 2 is a flowchart illustrating a method for processing and validating user-submitted transaction data in accordance with an embodiment of the present invention.

FIG. 3 is a block diagram illustrating a metadata extraction and validation module in accordance with an embodiment of the present invention.

FIG. 4 is a block diagram illustrating an image authenticity verification module in accordance with an embodiment of the present invention.

FIG. 5 is a block diagram illustrating a geo-temporal validation module in accordance with an embodiment of the present invention.

FIG. 6 is a block diagram illustrating a text extraction and integrity assessment module in accordance with an embodiment of the present invention.

FIG. 7 is a block diagram illustrating a composite confidence scoring engine in accordance with an embodiment of the present invention.

FIG. 8 is a flowchart illustrating a conditional AI invocation orchestration process in accordance with an embodiment of the present invention.

FIG. 9 is a block diagram illustrating a human-in-the-loop validation interface in accordance with an embodiment of the present invention.

### DETAILED DESCRIPTION OF THE INVENTION

The present invention will now be described more fully hereinafter with reference to the accompanying drawings, in which preferred embodiments of the invention are shown. The described embodiments are illustrative and exemplary rather than exhaustive or limiting. The invention is not limited to the precise embodiments described. Many variations, modifications, substitutions, and equivalents will be apparent to persons skilled in the art upon reading this disclosure. Features described in connection with one embodiment may be combined with features from other embodiments to create additional embodiments not explicitly described. The absence of explicit description of a particular combination of features does not indicate that such combination is excluded from the scope of the invention.

Throughout this specification, the terms “submission data,” “transaction data,” “input data,” “user-submitted data,” “user-generated data,” “user-provided data,” and similar expressions are used interchangeably to refer to data received and processed by the system disclosed herein. These terms should be construed broadly and are not intended to limit the scope of the invention to any particular data format, structure, content type, or origin. “Submission data” encompasses, but is not limited to: media files including images, photographs, digital pictures, video recordings, video frames, scanned documents, screenshots, or other visual content in any digital format; metadata including location data (GPS coordinates, Wi-Fi positioning, cellular triangulation), timestamps (capture time, submission time, modification time), device identifiers (advertising IDs, device models, operating system versions), capture attributes (resolution, orientation, camera settings, EXIF data), network context information, or sensor data; extracted information including recognized text, optical character recognition results, structured fields, parsed content, identified entities, or derived data; user-provided information including manual annotations, corrections to automatically extracted data, confirmations, explanations, contextual details, or supplementary information; and any combination, subset, or derivative of the foregoing.

“Transaction data” refers to information pertaining to retail transactions, purchases, pricing information, promotional offers, discounts, rebates, coupons, or commercial activities occurring in offline retail environments including physical stores, shopping centers, markets, or other brick-and-mortar retail locations. The use of the term “transaction” or “transaction data” does not limit the invention to completed purchase transactions and expressly encompasses: pricing observations from shelf tags, price labels, or product displays; promotional materials including signs, posters, banners, or advertisements; pre-purchase information gathering or price comparison activities; window shopping or browsing activities; any retail-related information whether or not an actual purchase occurred. “Input data” refers to any data provided as input to the system, any module, any component, any engine, any processor, or any processing logic described herein. Input data may include raw submission data as received from client devices, intermediate processing results generated by one component and provided to another, derived information computed from original submission data, or any other data that flows through the system during processing.

The selection of terminology in any particular instance throughout this specification is made for descriptive convenience, clarity of explanation, and readability. No inference should be drawn regarding limitation of claim scope, functional boundaries, or structural requirements based on the particular term selected in any portion of the detailed description. All such terms should be understood to encompass the full range of data received, processed, analyzed, or generated by the system as described herein and as would be understood by persons of ordinary skill in the art based on the disclosure provided.

References to “images” should be understood to encompass still photographs, single image frames, sequences of images, video recordings, video frames extracted from recordings, scanned documents converted to image format, screenshots, screen captures, or any visual representation in digital form captured, generated, or provided by users or client devices. References to “retail information” encompass prices, costs, discounts, promotional offers, rebates, coupons, sale information, clearance information, product information, product descriptions, merchant information, merchant names, merchant identifiers, store locations, store addresses, operating hours, business hours, promotional periods, validity dates, expiration dates, or any information related to retail commerce, pricing, or commercial transactions.

The use of specific examples such as “receipt images,” “price tag photographs,” “promotional signage pictures,” or similar illustrations is provided for clarity and understanding and is not intended to limit the invention to those specific document types, formats, or capture scenarios. The invention applies equally to any form of user-submitted visual evidence, textual information, or metadata related to retail information from offline environments, regardless of the specific document type, physical format, digital format, capture method, or submission mechanism.

Throughout this specification, various structural and functional terms are used to describe the architecture and organization of the disclosed system. These terms include but are not limited to “module,” “component,” “engine,” “subsystem,” “system,” “unit,” “processor,” “analyzer,” “scorer,” “detector,” “validator,” “evaluator,” “extractor,” “assessor,” “calculator,” and similar expressions. These structural and functional terms are used for organizational clarity in describing the functional capabilities and logical architecture of the invention. The use of such terms does not necessarily imply, require, or mandate: physical separation of the described elements; distinct hardware implementations for different modules or components; particular software boundaries, library divisions, or code organization; separate processors, servers, or computing devices for different modules; specific memory allocation or storage separation; independent execution threads, processes, or virtual machines; and any particular degree of coupling, independence, or isolation.

A single hardware processor, processing core, or computing device may implement multiple described modules, components, or engines. Conversely, a single described module, component, or engine may be distributed across multiple processors, processing cores, computing devices, or geographic locations. The functional partitioning, modular organization, and architectural structure described herein represent one possible and illustrative implementation approach for clarity of explanation and should not be construed as limiting the invention to any particular hardware configuration, software architecture, deployment topology, or implementation methodology. Modules and components described as “operatively coupled,” “operatively connected,” “communicatively coupled,” or similar expressions may communicate through any suitable mechanism including but not limited to function calls within a single process, inter-process communication mechanisms, network protocols, message queues, shared memory, database tables, file systems, or any other data exchange mechanism. The described modules and components may be implemented as hardware circuits, application-specific integrated circuits (ASICs), field-programmable gate arrays (FPGAs), software instructions stored on computer-readable media and executable by processors, firmware, or any combination of hardware and software. The selection of implementation approach is a matter of design choice and does not limit the scope of the invention. References to data being “provided to,” “transmitted to,” “sent to,” “forwarded to,” or “received by” a particular module or component should be understood functionally rather than requiring any particular data transfer mechanism, communication protocol, or physical transmission.

Throughout this specification, various algorithms, computational methods, analytical techniques, and processing approaches are described or referenced. These include but are not limited to image signature algorithms, efficient similarity matching, Hamming distance computation, time-decay models, Kalman filtering, particle filtering, geofencing algorithms, distance calculations, optical character recognition engines, natural language processing algorithms, regular expression matching, statistical analysis methods, outlier detection algorithms, Gaussian mixture models, isolation forests, support vector machines, Bayesian networks, neural networks, machine learning models, and various other computational techniques. The specification of particular algorithms or methods is provided for illustrative purposes to demonstrate feasible implementation approaches and to enable persons skilled in the art to make and use the invention. Such specifications should not be construed as limiting the invention to only those particular algorithms or methods unless explicitly claimed as such. For example, where image signature is described, any image signature algorithm including but not limited to dHash, aHash, pHash, wavelet-based hashing, or future developed image signature techniques may be employed. Where machine learning models are described, any suitable supervised learning algorithm, unsupervised learning algorithm, semi-supervised learning algorithm, deep learning architecture, or other machine learning approach may be utilized. References to specific software libraries, APIs, services, or tools (such as text extraction engines OCR, cloud-based text extraction services, etc.) are illustrative examples of commercially available implementations and do not limit the invention to those specific implementations.

This specification describes various embodiments of the invention including a system embodiment, a method embodiment, and a computer-readable medium embodiment. Additionally, various alternative embodiments and variations are described including on-device processing embodiments, cloud-based processing embodiments, hybrid processing embodiments, real-time processing embodiments, and batch processing embodiments.

Optional features, alternative implementations, and variant configurations described using language such as “may,” “can,” “could,” “might,” “in some embodiments,” “in certain embodiments,” “in one embodiment,” “in alternative embodiments,” or similar conditional or qualifying language should be understood as describing features that are encompassed by the invention but are not necessarily required in all implementations. Where multiple alternative approaches are described (for example, “weighted averaging, geometric mean, or neural network models” for confidence aggregation), the invention encompasses all described alternatives as well as other equivalent alternatives not explicitly enumerated but achievable through application of ordinary skill in the art. The division of the disclosure into sections such as “system embodiment,” “method embodiment,” and “computer-readable medium embodiment” is for organizational clarity. Features described in one section are not limited to that particular type of embodiment and may be applicable across different embodiment types.

Throughout this specification, unless explicitly stated otherwise or clear from context, the use of singular forms such as “a,” “an,” and “the” include plural references, and the use of plural forms include singular references. For example, reference to “a module” encompasses embodiments having one module as well as embodiments having multiple modules. Reference to “modules” encompasses embodiments having multiple modules as well as embodiments having a single module performing the described functions. Similarly, reference to “an image” encompasses single images as well as multiple images or collections of images. Reference to “data” encompasses singular data items as well as collections or aggregations of data. This convention applies throughout the specification including the claims unless explicitly contradicted by specific language or context.

The present invention provides a system and method for multi-dimensional verification of user-submitted transaction data. The invention addresses the need to validate images of receipts, price tags, and promotional materials along with their associated metadata through multiple independent verification dimensions including metadata validation, image authenticity assessment, geo-temporal verification, text extraction and integrity checking, and market plausibility evaluation. Rather than employing rigid binary accept-reject decisions, the invention implements adaptive confidence scoring wherein each verification dimension generates a confidence score, and these scores are aggregated into a composite confidence metric. This approach enables appropriate degradation where the transaction data with missing or degraded data can still be processed, albeit with reduced confidence, rather than being automatically rejected.

The invention further implements conditional processing orchestration wherein expensive or computationally intensive validation modules are invoked selectively based on confidence scores and other triggering conditions. This optimizes resource utilization by directing advanced processing toward submitted transaction data that warrant additional scrutiny. Additionally, the invention incorporates human-in-the-loop mechanisms through user interfaces that present validation results with confidence indicators and enable users to confirm, correct, or override system determinations. User feedback is logged and used to improve system accuracy through validation parameter updates and model retraining.

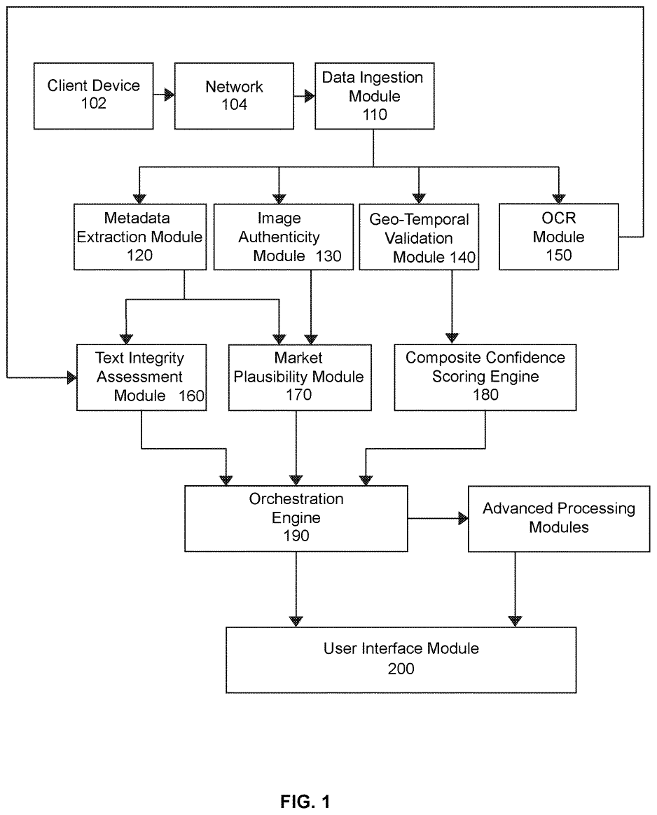

Referring to FIG. 1, a high-level architecture of a system 100 of the present invention is illustrated. The architecture demonstrates the hardware and software components, their interconnections, and how they operate together to perform multi-dimensional verification of user-submitted transaction data. The system 100 for multi-dimensional verification of user-submitted transaction data comprises a client device 102 such as a mobile computing device, smartphone, tablet computer, or other portable electronic device equipped with image capture capabilities, location determination capabilities, and network communication capabilities. The client device 102 is configured to capture media files such as images of receipts, price tags, promotional materials, or other transaction-related documents, and to collect associated metadata including location data, timestamps, device identifiers, and image capture attributes. The client device 102 communicates, via a communication network 104, to backend processing components. The network 104 may comprise the Internet, cellular networks, Wi-Fi networks, or combinations thereof. The system 100 further includes data ingestion module 110, communicatively coupled to the client device 102 via the network 104 and configured to receive input data packets from the client device 102. Each input data packet comprises at least one media file and associated metadata.

The system also comprises a metadata extraction module 120 operatively connected to the data ingestion module 110 and configured to parse and extract metadata attributes from the input data. The metadata extraction module 120 processes various types of metadata including location data with latitude and longitude coordinates and accuracy radius, timestamp data including capture time and submission time, device identifiers which may be non-persistent or anonymized, image capture attributes including orientation and resolution, and optional network context data such as coarse network location.

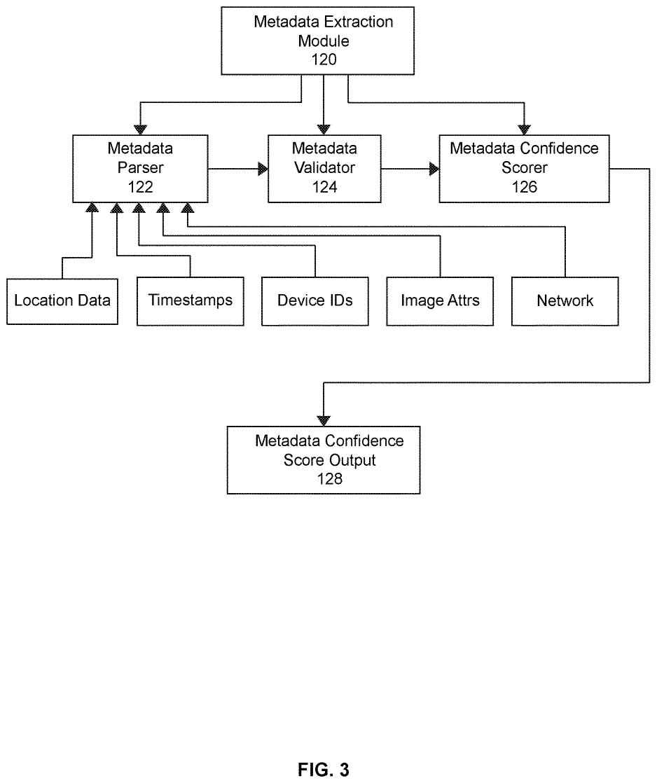

As illustrated in FIG. 3, the metadata extraction module 120 comprises a metadata parser 122 which is configured to extract metadata from various sources and formats, including EXIF data embedded in image files, JSON-formatted metadata transmitted alongside media files, and proprietary metadata formats specific to particular client devices or applications. The metadata extraction module 120 further comprises a metadata validator 124 which is configured to assess metadata completeness and consistency. In some aspects, the metadata validator 124 performs validation checks including range validation to ensure coordinate values fall within valid geographic bounds, temporal validation to ensure timestamps represent plausible dates and times, and cross-field validation to identify inconsistencies among related metadata attributes. Further, a metadata confidence scorer 126 is configured to assign confidence values 128 to individual metadata attributes based on availability, consistency, and plausibility. An image authenticity module 130 is operatively coupled to the metadata extraction module 120 and configured to perform image authenticity verification.

The metadata extraction module 120 with integrated validation and confidence scoring provides the advantage of early-stage data quality assessment, enabling the system to identify and flag submissions with incomplete or inconsistent metadata before expending computational resources on more intensive validation processes. This early filtering improves overall system efficiency and enables graceful handling of submissions with degraded metadata quality rather than outright rejection.

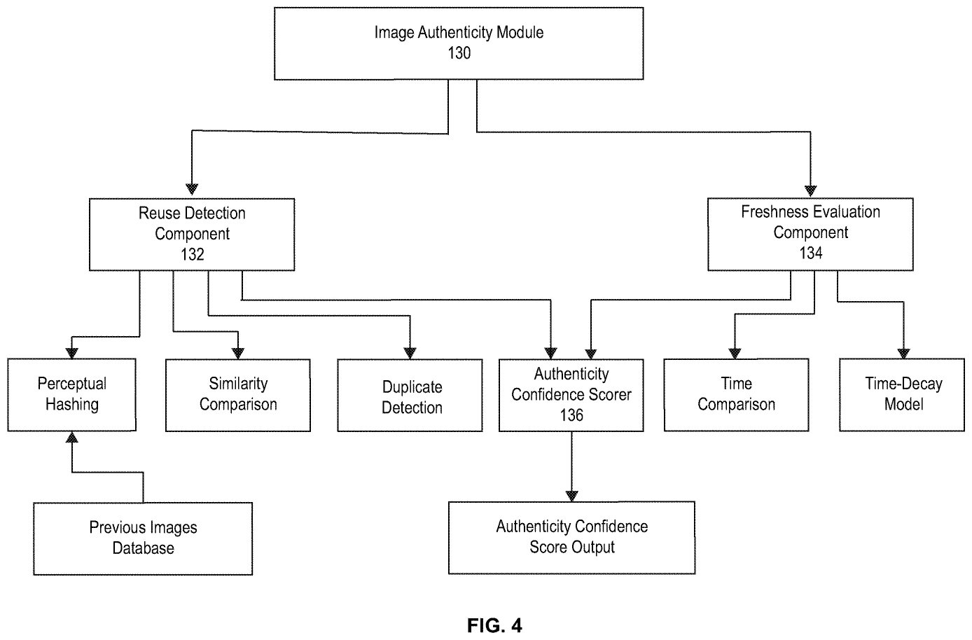

As shown in FIG. 4, the image authenticity module 130 comprises a reuse detection component 132 which is configured to implement perceptual hashing or fingerprinting algorithms to generate compact representations of submitted images, perform similarity comparison against a database of previously submitted images, and detect near-duplicates across different users or across different time periods. In one embodiment, the reuse detection component 132 employs locality-sensitive hashing (LSH) algorithms to efficiently identify similar images in large-scale databases. A freshness evaluation component 134 is configured to compare capture time metadata against submission time metadata, apply time-decay confidence models wherein confidence decreases as the time difference between capture and submission increases, and perform cross-checks with prior submissions from the same user or device to identify patterns of delayed submissions. The image authenticity module 130 further comprises an authenticity confidence scorer 136 which is configured to aggregate results from the reuse detection component 132 and the freshness evaluation component 134 to generate an authenticity confidence score. In certain embodiments, authenticity failures may cause outright rejection of the submission, while in other embodiments, authenticity concerns may result in degraded confidence requiring additional validation or human confirmation.

The image authenticity module 130 combining reuse detection and freshness evaluation provides the advantage of detecting both cross-user image duplication and temporal manipulation through delayed submission of old images. The use of perceptual hashing with locality-sensitive hashing enables efficient detection of near-duplicate images even when images have been modified through compression, cropping, or filtering, providing robust fraud detection that adapts to common manipulation techniques.

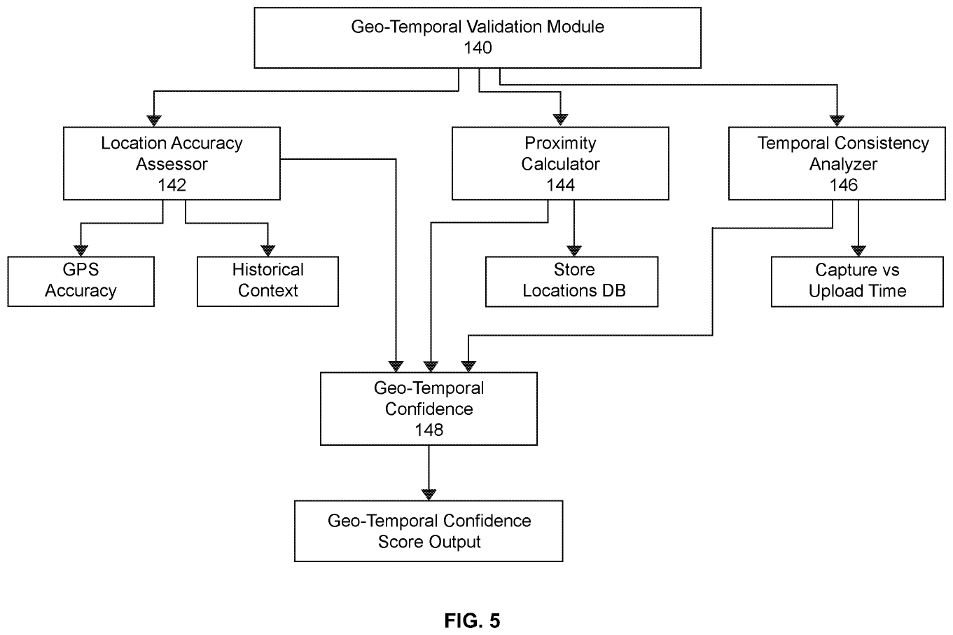

The system further includes a geo-temporal validation module 140 which is operatively coupled to the metadata extraction module 120 and configured to perform location and temporal validation of submitted input data. Referring to FIG. 5, the geo-temporal validation module 140 comprises a location accuracy assessor 142 which is configured to evaluate the accuracy of location data, including raw GPS accuracy metrics, corrected or inferred location data using historical context, and confidence scoring based on accuracy radius. In one embodiment, the location accuracy assessor 142 implements Kalman filtering or particle filtering algorithms to improve location estimates. A proximity calculator 144 is configured to calculate distances between the reported location and known or inferred store locations, apply flexible distance thresholds depending on context such as mall environments versus standalone stores, and account for indoor positioning challenges. In certain embodiments, the proximity calculator 144 maintains a geospatial database of retail locations and implements geofencing algorithms to determine whether a reported location falls within acceptable proximity to valid transaction locations.

The image authenticity module 130 combining reuse detection and freshness evaluation provides the advantage of detecting both cross-user image duplication and temporal manipulation through delayed submission of old images. The use of image signature with efficient similarity matching enables efficient detection of near-duplicate images even when images have been modified through compression, cropping, or filtering, providing robust fraud detection that adapts to common manipulation techniques.

Further, a temporal consistency analyzer 146 is configured to compare capture time against upload time, evaluate time delays wherein delays reduce confidence but do not necessarily invalidate data, assess deal validity windows sourced from extracted text or inferred from historical submission patterns, and identify temporal anomalies. A geo-temporal confidence scorer 148 is configured to aggregate outputs from the location accuracy assessor, proximity calculator 144, and temporal consistency analyzer 146 to generate a geo-temporal confidence score. The geo-temporal validation module 140 with flexible, context-dependent thresholds provides the advantage of accommodating legitimate variability in GPS accuracy due to indoor positioning challenges, urban canyon effects, and device-specific positioning capabilities, while still detecting suspicious location claims. The integration of temporal consistency analysis with deal validity windows and store operating hours enables detection of temporally implausible submissions without requiring rigid timestamp matching.

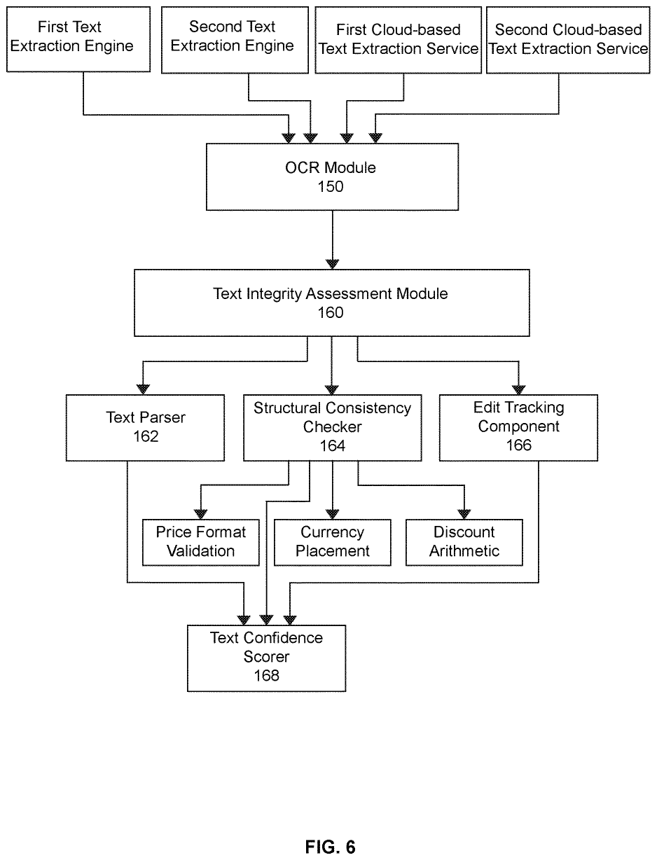

The system further includes an optical character recognition (OCR) module, referred to herein as a text extraction module 150, configured to extract textual information from submitted media files. In certain embodiments, the text extraction module 150 employs multiple text extraction engines, as shown in FIG. 6, such as a first text extraction engine and a second text extraction engine, and a first cloud-based text extraction service and a second cloud-based text extraction service, in parallel and aggregates results to improve extraction accuracy.

The system 100 also includes a text integrity assessment module 160 which is operatively coupled to the text extraction module 150 and configured to validate extracted textual information. As illustrated in FIG. 6, the text integrity assessment module 160 comprises a text parser 162 which is configured to process raw OCR output and extracts structured fields including prices, dates, merchant names, product descriptions, and promotional offer details. The text parser 162 implements natural language processing (NLP) algorithms and regular expression matching to identify and extract relevant information. The text integrity assessment module 160 further includes a structural consistency checker 164 which is configured to validate price format consistency including currency symbol placement and decimal separators, verify currency placement according to locale-specific conventions, assess discount arithmetic consistency by verifying that calculated discounts match stated percentages or amounts, and identify anomalies in text structure that may indicate manipulation or OCR errors. An edit tracking component 166 is configured to track user edits to extracted text, logging original OCR output and user-corrected values. A text confidence scorer 168 is configured to compute confidence scores based on OCR quality, structural consistency validation results, and user edit patterns.

The text integrity assessment module 160 with structural consistency checking and edit tracking provides the advantage of validating not only OCR accuracy but also the logical coherence and arithmetic consistency of extracted information. By verifying that discount calculations match stated percentages and that price formats follow locale-specific conventions, the system detects manipulated or fabricated pricing information that would produce syntactically valid but semantically inconsistent text. The edit tracking component enables the system to learn from user corrections and distinguish between legitimate OCR error corrections and potential data manipulation.

The system 100 further includes a behavioral and market plausibility module 170 which is configured to evaluate submitted transaction data against historical patterns and market norms. In one embodiment, the behavioral and market plausibility module 170 comprises a historical price database which maintains a plurality of data including historical price information for products, product categories, merchants, and geographic regions. A price range analyzer is configured to compare submitted prices against historical price ranges, accounting for temporal variations, geographic variations, and promotional periods. An outlier detection component is configured to implement statistical algorithms to identify input data that represent significant deviations from expected patterns. In one embodiment, the outlier detection component employs Gaussian mixture models, isolation forests, or one-class support vector machines to identify anomalous submissions. The outlier detection component performs cross-validation with peer submissions, analyzing whether similar products at similar locations show similar pricing, and evaluates store-level consistency over time. A plausibility confidence scorer is configured to generate confidence scores based on price range analysis and outlier detection results.

The behavioral and market plausibility module 170 provides the advantage of validating the economic reasonableness of submitted pricing information through comparison with historical price databases and statistical outlier detection. This market-level validation detects fraudulent or erroneous pricing claims that would pass image and location validation, such as fabricated discounts or manipulated prices. The cross-validation with peer submissions enables identification of anomalous pricing patterns across multiple dimensions including product category, merchant, geographic region, and temporal context.

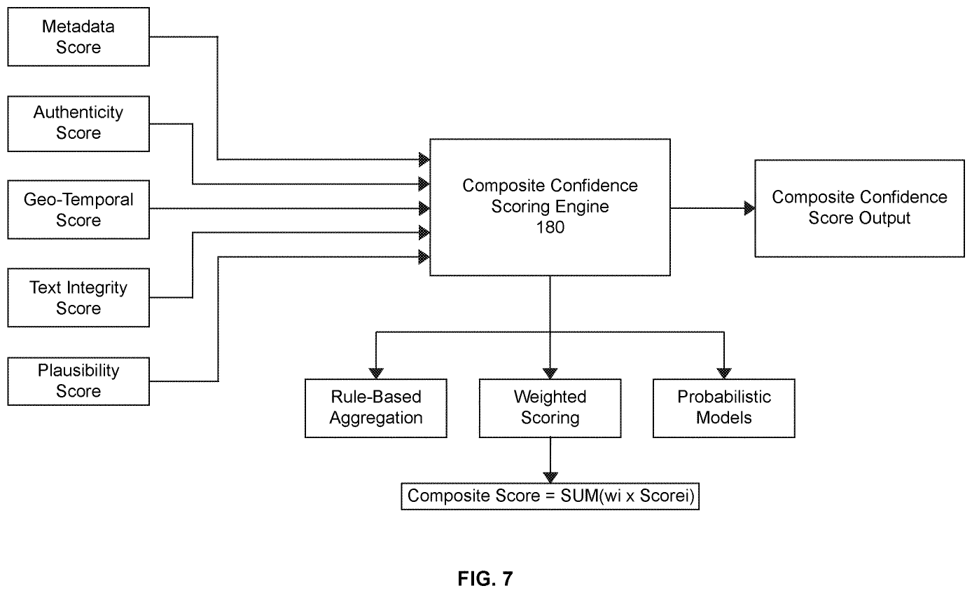

The system further includes a composite confidence scoring engine 180 which is configured to aggregate confidence scores from multiple verification dimensions to compute an overall composite confidence score for each submission. Referring to FIG. 7, the composite confidence scoring engine 180 receives inputs from the metadata confidence scorer 126, the authenticity confidence scorer 136, the geo-temporal confidence scorer 148, the text confidence scorer 168, and the plausibility confidence scorer. The composite confidence scoring engine 180 implements one or more aggregation approaches, which may include rule-based aggregation wherein predefined rules determine how individual scores combine, weighted scoring wherein different verification dimensions receive different weights based on their relative importance, probabilistic aggregation employing Bayesian networks or other probabilistic models, or learned models trained on historical validation data using machine learning algorithms.

In one illustrative embodiment, the composite confidence scoring engine 180 implements a weighted linear aggregation function. The composite confidence score may be expressed as a numerical value, a categorical label such as high, medium, or low confidence, or a combination thereof. In certain embodiments, the composite confidence scoring engine 180 generates confidence intervals or uncertainty estimates associated with the composite confidence score.

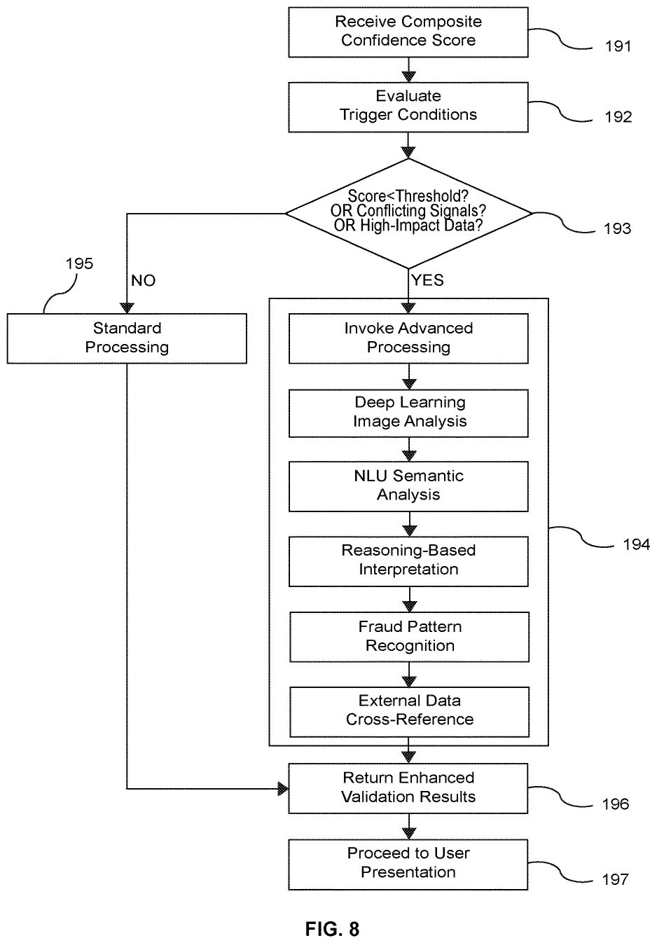

The system also includes an orchestration engine 190 which is configured to conditionally invoke advanced processing modules based on the composite confidence score and other triggering conditions. Referring to FIG. 8, the orchestration engine 190 implements a cost-controlled orchestration strategy wherein computationally intensive or expensive processing modules are invoked selectively based on need rather than uniformly for all submissions. In an exemplary embodiment, the orchestration engine 190 receives 191 composite confidence score evaluates 192 a plurality of trigger conditions including composite confidence score falling below a predetermined threshold, detection of conflicting signals among different verification dimensions, identification of high-impact data such as unusually large discounts or high-value transactions, and specific patterns or anomalies flagged by individual verification modules. Upon detection 193 of one or more trigger conditions, the orchestration engine 190 selectively invokes 194 one or more advanced processing modules. If the trigger conditions do not satisfy, standard processing 195 is implemented.

The advanced processing modules may include advanced image analysis employing deep learning-based image classification, object detection, or scene understanding; natural language understanding for semantic analysis of extracted text; reasoning-based interpretation employing large language models or expert systems; fraud pattern recognition employing trained classifiers; or cross-reference validation against external data sources. The orchestration engine 190 implements cost-awareness mechanisms, tracking computational costs, API invocation costs, or processing time associated with different advanced processing modules, and making 196 invocation decisions that balance validation accuracy against processing costs.

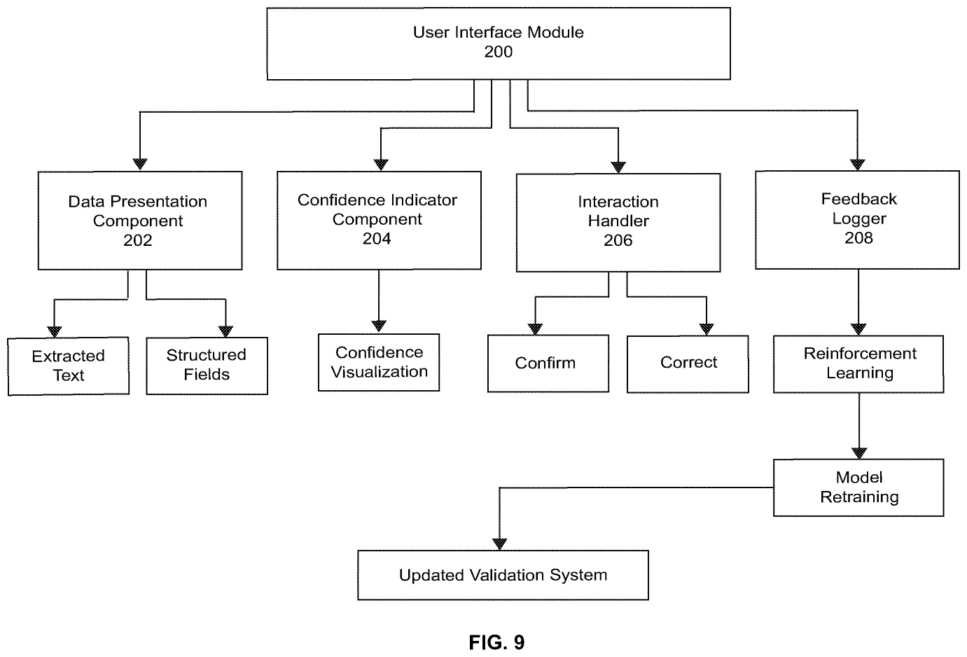

The system further includes a user interface module 200 which is configured to present 197 (FIG. 8) validation results to users and collect user feedback. Referring to FIG. 9, the user interface module 200 comprises a data presentation component 202 which is configured to display extracted information including recognized text, structured fields, and metadata to users via a graphical user interface rendered on the client device 102 or a web interface accessible via a browser. A confidence indicator component 204 is configured to display confidence indicators, warnings, or uncertainty messages associated with the validation results, enabling users to understand the system's assessment of data quality. In one embodiment, an interaction handler 206 is configured to receive user actions including confirmation of extracted information, correction of errors, override of system determinations, or provision of additional context. A feedback logger 208 maintains a record of user interactions for subsequent analysis and system improvement.

The client device 102 is communicatively coupled to the data ingestion module 110 via the network 104. The client device 102 transmits one or more input data packets to the data ingestion module 110, wherein each input data packet comprises at least one media file and associated metadata. The data ingestion module 110 is operatively connected to the metadata extraction module 120. Upon receiving one of the input data packets, the data ingestion module 110 forwards the input data to the metadata extraction module 120 for parsing and validation. The metadata extraction module 120 extracts metadata attributes from the input data and provides the attributes to both the image authenticity module 130 and the geo-temporal validation module 140. Specifically, timestamp data extracted by the metadata extraction module 120 is provided to the freshness evaluation component 134 of the image authenticity module 130. Location data and timestamp data extracted by the metadata extraction module 120 are provided to the geo-temporal validation module 140. The metadata extraction module 120 also provides image files to the image authenticity module 130 for reuse detection and to the text extraction module 150 for text extraction.

The image authenticity module 130 operates independently on the submitted images to detect reuse and evaluate freshness, generating an authenticity confidence score that is provided to the composite confidence scoring engine 180. The geo-temporal validation module 140 evaluates location and temporal aspects of the input data, and generates a geo-temporal confidence score that is provided to the composite confidence scoring engine 180. The text extraction module 150 receives media files from the metadata extraction module 120 and extracts textual information, and provides raw extracted text output to the text integrity assessment module 160. The text integrity assessment module 160 processes the extracted text output to extract structured fields, validate structural consistency, track user edits, and generate a text confidence score that is provided to the composite confidence scoring engine 180. In one aspect, extracted text data is also provided to the behavioral and market plausibility module 170 for price comparison and outlier detection. The behavioral and market plausibility module 170 compares extracted pricing information against the historical price database, performs outlier detection, and generates a plausibility confidence score that is provided to the composite confidence scoring engine 180. The composite confidence scoring engine 180 receives confidence scores from all verification dimensions (metadata confidence scorer 126, authenticity confidence scorer 136, geo-temporal confidence scorer 148, text confidence scorer 168, and plausibility confidence scorer) and aggregates these scores into a composite confidence score. The composite confidence score is provided to the orchestration engine 190, which evaluates trigger conditions and determines whether to invoke advanced processing modules. If advanced processing is invoked, results from advanced processing modules are fed back to the composite confidence scoring engine 180 to update the composite confidence score.

The final validation results, including the composite confidence score and extracted data, are provided to the user interface module 200 for presentation to the user. The user interface module 200 receives user feedback through the interaction handler 206 and logs the feedback via the feedback logger 208. User feedback influences future validation and scoring through validation parameter adjustment mechanisms.

The workflow of the system 100 is described herein according to an exemplary embodiment of the present invention. In one embodiment, the system 100 implements on-device processing wherein validation logic executes directly on the client device 102 rather than in cloud infrastructure. In this embodiment, the metadata extraction module 120, image authenticity module 130, geo-temporal validation module 140, text extraction module 150, text integrity assessment module 160, and portions of the behavioral and market plausibility module 170 are implemented as software components executing on the client device 102. In various aspects, on-device processing provides advantages of reduced latency, privacy preservation as sensitive image and metadata never leave the device, and operation in offline or low-connectivity scenarios. However, on-device processing may employ lightweight models and reduced historical databases due to device resource constraints.

In an alternative embodiment, the system 100 implements cloud-based processing wherein the data ingestion module 110, metadata extraction module 120, image authenticity module 130, geo-temporal validation module 140, text extraction module 150, text integrity assessment module 160, behavioral and market plausibility module 170, composite confidence scoring engine 180, and orchestration engine 190 are implemented as distributed services executing on remote servers. In various aspects, cloud-based processing provides advantages of access to greater computational resources, centralized model updates, historical databases, and cross-user analysis capabilities for improved fraud detection through pattern recognition across multiple users.

In yet another embodiment, the system 100 implements hybrid processing wherein certain processing tasks execute on-device while others execute in the cloud. For example, metadata extraction and initial OCR may be performed on the client device 102 to provide immediate user feedback, while image authenticity assessment, geo-temporal validation, text integrity assessment, and market plausibility evaluation are performed in the cloud to leverage comprehensive databases and machine learning models.

In one embodiment, verification occurs in real-time during or immediately after submission. The client device 102 transmits input data to the data ingestion module 110, which triggers immediate processing through all validation modules. The result or output data are returned to the user interface module 200 within seconds, thereby enabling interactive user experience where users can immediately view validation results and provide corrections if needed.

In an alternative timing embodiment, the input data are queued and processed asynchronously in batch mode. This approach is suitable when immediate results are not required and allows for optimization of computational resource utilization by processing multiple submissions together and scheduling processing during off-peak hours.

The operational workflow of system 100 demonstrates how the previously described components interact and operate in coordination to validate user-submitted transaction data. The workflow begins when client device 102 receives at least one input data packet including a media file, such as an image file of a physical retail store, and collects associated metadata therefrom. The client device 102 transmits input data comprising the media file and metadata to data ingestion module 110 via network 104. The data ingestion module 110 receives the input data packet, performs initial validation to ensure proper formatting and compliance with size and format requirements, and assigns a unique submission identifier to track the submission through subsequent processing stages.

Upon successful receipt and initial validation, data ingestion module 110 forwards the input data to metadata extraction module 120. The metadata parser 122 of the metadata extraction module 120 extracts metadata attributes from multiple sources including EXIF data embedded in the image file and JSON-formatted metadata transmitted alongside the media file. The extracted metadata attributes include location data comprising latitude, longitude, and accuracy radius; timestamp data comprising capture timestamp and submission timestamp; device identifier data; and image capture attributes. The metadata validator 124 performs validation checks on the extracted metadata, including range validation to ensure GPS coordinates fall within valid geographic bounds, temporal validation to ensure the capture timestamp precedes the submission timestamp and neither timestamp is in the future, and cross-field validation to identify inconsistencies among related attributes. The metadata confidence scorer 126 computes a metadata confidence score based on the completeness, consistency, and plausibility of the extracted metadata attributes.

Concurrently with metadata extraction, or following metadata extraction, the metadata extraction module 120 provides the extracted timestamp data to freshness evaluation component 134 of image authenticity module 130. The metadata extraction module 120 also provides the media file itself to reuse detection component 132 of the image authenticity module 130. The reuse detection component 132 computes an image signature of the image file using image signature algorithms that generate a compact representation capturing the visual content of the image. The reuse detection component 132 queries a database of previously submitted image hashes using efficient similarity matching algorithms to efficiently identify images with similar image signatures. If near-duplicate images are found, particularly if submitted by different users, the reuse detection component 132 generates a low reuse detection confidence score indicating potential fraudulent reuse. If no near-duplicates are found, a high reuse detection confidence score is generated.

Simultaneously, the freshness evaluation component 134 receives the capture timestamp and submission timestamp from metadata extraction module 120 and computes the time difference between capture and submission. The freshness evaluation component 134 applies time-decay confidence models wherein confidence decreases as the time difference increases, reflecting reduced confidence that delayed submissions represent fresh content rather than potentially fraudulent reuse of old images. The freshness evaluation component 134 generates a freshness confidence score based on the computed time difference. The authenticity confidence scorer 136 receives the reuse detection confidence score from reuse detection component 132 and the freshness confidence score from freshness evaluation component 134, and aggregates these scores to generate an overall authenticity confidence score representing the likelihood that the submitted image is genuine and freshly captured.

In parallel with image authenticity assessment, the metadata extraction module 120 provides the extracted location data and timestamp data to geo-temporal validation module 140. The location accuracy assessor 142 evaluates the reliability of the location data by examining the accuracy radius provided in the metadata. In embodiments implementing statistical filtering, the location accuracy assessor 142 may combine the current location measurement with historical location data for the user to generate an improved location estimate with reduced uncertainty. The location accuracy assessor 142 generates a location accuracy metric representing confidence in the reported location based on the accuracy radius provided in the metadata and, in embodiments employing filtering algorithms, based on the uncertainty reduction achieved through filtering.

The proximity calculator 144 receives the location data and retrieves known locations of retail stores from a geospatial database. The proximity calculator 144 computes geographic distances between the reported location and each known store location using distance calculation algorithms such as the haversine formula for great circle distance on a sphere. The proximity calculator 144 applies context-dependent distance thresholds, using larger thresholds for mall environments where multiple stores exist in close proximity and smaller thresholds for standalone stores. In one embodiment, the proximity calculator 144 implements geofencing algorithms to determine whether the reported location falls within acceptable proximity to any valid transaction location. If the reported location is within acceptable proximity, a high proximity confidence is generated; otherwise, a low proximity confidence is generated.

The temporal consistency analyzer 146 receives the capture timestamp and submission timestamp and evaluates the submission delay. While submission delays reduce confidence, the temporal consistency analyzer 146 implements models that degrade confidence gradually rather than rejecting delayed submissions outright. The temporal consistency analyzer 146 also accesses extracted text data to identify promotional validity periods or expiration dates mentioned in the extracted text, and compares the capture timestamp against these validity windows. Additionally, the temporal consistency analyzer 146 may access store operating hours data to verify that the capture timestamp falls within periods when the identified store was open for business. The temporal consistency analyzer 146 generates a temporal consistency metric based on these evaluations.

The geo-temporal confidence scorer 148 receives the location accuracy metric from location accuracy assessor 142, the proximity confidence from proximity calculator 144, and the temporal consistency metric from temporal consistency analyzer 146. In one aspect, the geo-temporal confidence scorer 148 aggregates these inputs to generate an overall geo-temporal confidence score representing the plausibility of the reported location and timing of the submission.

Concurrently with the authenticity and geo-temporal validation processes, the metadata extraction module 120 provides the media file to text extraction module 150. The text extraction module 150 applies one or more text extraction engines to the media file to recognize and extract textual information. In embodiments employing multiple text extraction engines in parallel, the text extraction module 150 invokes each text extraction engine independently and receives raw extracted text output from each engine. The text extraction module 150 aggregates results from multiple engines using voting mechanisms where text recognized consistently across engines is accepted with high confidence, or using confidence-weighted selection where text from the engine reporting highest confidence is selected. The text extraction module 150 generates raw extracted text output data comprising recognized text and associated confidence scores indicating the certainty of each recognized word or character.

The text extraction module 150 provides the raw extracted text output data to text integrity assessment module 160. The text parser 162 processes the raw extracted text output to identify and extract structured fields including merchant names, product descriptions, prices, dates, and promotional offer details. The text parser 162 implements natural language processing algorithms to recognize entities such as merchant names and product descriptions, and implements regular expression matching to identify prices formatted with currency symbols and decimal separators, and dates formatted in various date formats.

The structural consistency checker 164 receives the extracted structured fields and validates their consistency. The structural consistency checker 164 verifies that prices follow expected formatting conventions with currency symbols properly positioned according to locale-specific rules. The structural consistency checker 164 performs arithmetic validation by computing sums of line item prices and comparing against total amounts, or by computing discount amounts from original and discounted prices and verifying that these match stated discount percentages. Inconsistencies in arithmetic indicate potential manipulation or extraction error and result in reduced confidence.

If the user interface enables users to edit extracted text, the edit tracking component 166 monitors for user modifications. When a user edits an extracted field, the edit tracking component 166 logs the original extracted text output value and the user-corrected value. The magnitude and nature of edits influence confidence scoring, as extensive modifications suggest poor text extraction quality or potential user manipulation, while minor corrections of single-character extraction error suggest legitimate error correction.

The text confidence scorer 168 receives inputs from text parser 162 indicating extraction confidence scores, from structural consistency checker 164 indicating results of arithmetic and format validation, and from edit tracking component 166 indicating the extent and nature of user edits. The text confidence scorer 168 aggregates these inputs to generate a text integrity confidence score representing the reliability and accuracy of the extracted textual information.

In parallel with text integrity assessment, the extracted pricing information from text parser 162 is provided to behavioral and market plausibility module 170. The price range analyzer accesses historical price database to retrieve historical pricing information for the identified products, product categories, merchants, and geographic regions. The price range analyzer computes statistical measures from the historical data including mean prices, median prices, standard deviations, and price ranges. The price range analyzer compares the submitted prices against the historical price distributions, accounting for temporal variations by considering whether the submission falls within known promotional periods, and accounting for geographic variations by comparing against region-specific pricing norms.

The outlier detection component applies statistical algorithms to identify whether the submitted prices represent significant deviations from expected patterns. In embodiments employing Gaussian mixture models, the outlier detection component fits probability distributions to historical price data and computes the likelihood that the submitted prices would be observed under these distributions. In embodiments employing isolation forests or one-class support vector machines, the outlier detection component applies trained models that identify anomalous data points based on their statistical properties. The outlier detection component also performs cross-validation with peer submissions by querying for recent submissions from other users for similar products at similar locations and times, and comparing the submitted prices against peer-submitted prices to identify inconsistencies.

The plausibility confidence scorer receives inputs from price range analyzer indicating how well submitted prices align with historical ranges, and from outlier detection component indicating whether submitted prices are flagged as statistical outliers. The plausibility confidence scorer aggregates these inputs to generate a market plausibility confidence score representing the economic reasonableness of the submitted pricing information.

The composite confidence scoring engine 180 receives confidence scores from all verification dimensions: the metadata confidence score from metadata confidence scorer 126, the authenticity confidence score from authenticity confidence scorer 136, the geo-temporal confidence score from geo-temporal confidence scorer 148, the text integrity confidence score from text confidence scorer 168, and the market plausibility confidence score from plausibility confidence scorer. The composite confidence scoring engine 180 applies its configured aggregation approach to combine these heterogeneous confidence scores into a unified composite confidence score.

In embodiments implementing rule-based aggregation, the composite confidence scoring engine 180 applies predefined rules such as minimum threshold rules where the composite score equals the minimum of all component scores, or weighted minimum rules where the composite score is determined primarily by the lowest-scoring dimensions. In embodiments implementing weighted scoring, the composite confidence scoring engine 180 multiplies each component score by a predetermined weight reflecting the relative importance of that verification dimension, and sums the weighted scores to produce the composite score. In embodiments implementing probabilistic aggregation using Bayesian networks, the composite confidence scoring engine 180 treats component scores as evidence and computes posterior probabilities representing overall confidence given the observed evidence. In embodiments implementing learned models such as neural networks, the composite confidence scoring engine 180 provides component scores as inputs to a trained model that has learned optimal aggregation strategies from historical validation data and known outcomes.

The composite confidence scoring engine 180 provides the computed composite confidence score to orchestration engine 190. The orchestration engine 190 evaluates trigger conditions to determine whether advanced processing is warranted. The orchestration engine 190 compares the composite confidence score against a predetermined threshold; if the score falls below the threshold, this indicates uncertainty or ambiguity requiring additional validation. The orchestration engine 190 also examines the component scores to detect conflicting signals, such as high confidence in some dimensions but low confidence in others, which may indicate sophisticated fraud attempts. The orchestration engine 190 additionally checks whether the submission involves high-impact data such as unusually large transaction amounts or deep discounts that warrant extra scrutiny due to potential high financial impact.

When one or more trigger conditions are satisfied, the orchestration engine 190 selectively invokes advanced processing modules. The orchestration engine 190 may invoke deep learning-based image analysis modules that apply convolutional neural networks to detect sophisticated image manipulations not captured by image signature. The orchestration engine 190 may invoke natural language understanding modules that perform semantic analysis of extracted text to identify implausible promotional claims or inconsistent product descriptions. The orchestration engine 190 may invoke reasoning-based interpretation modules employing large language models that can assess the overall coherence and plausibility of the submission based on learned knowledge about retail transactions. The orchestration engine 190 may invoke fraud pattern recognition modules that apply trained classifiers to identify submissions matching known fraud patterns based on historical fraud cases.

The orchestration engine 190 implements cost-awareness mechanisms by tracking the computational costs, API invocation costs, or processing time associated with each advanced processing module. The orchestration engine 190 makes selective invocation decisions that balance the potential improvement in validation accuracy against the additional costs incurred, thereby optimizing resource utilization across many submissions. When advanced processing modules are invoked, the orchestration engine 190 receives results or output data from these modules and provides updated information back to composite confidence scoring engine 180, which recomputes the composite confidence score incorporating the additional validation signals from advanced processing.

Following completion of all validation processing, the composite confidence scoring engine 180 provides the final composite confidence score along with extracted and validated data to user interface module 200. The data presentation component 202 formats the extracted information for display, including recognized text, structured fields such as merchant names and prices, and metadata such as location and timestamps. The confidence indicator component 204 generates visual confidence indicators based on the composite confidence score, such as color-coded badges (green for high confidence, yellow for medium confidence, red for low confidence), numerical confidence percentages, or textual messages informing the user of the system's assessment.

The data presentation component 202 and confidence indicator component 204 render the formatted data and confidence indicators in a graphical user interface on client device 102 or in a web interface accessible via a browser. The user views the presented information and confidence indicators to understand the system's validation results. The interaction handler 206 monitors for user actions through the interface. If the user confirms that the extracted information is accurate, the interaction handler 206 records this confirmation. If the user identifies errors and makes corrections to extracted fields, the interaction handler 206 captures the original values and corrected values. If the user overrides a system determination (such as accepting a submission flagged with low confidence) and provides an explanation, the interaction handler 206 records the override and explanation.

The stored feedback data enables continuous system improvement through adaptive learning processes that analyze patterns in user confirmations and corrections to adjust validation parameters; for example, if users consistently correct specific types of extraction error, the system learns to flag similar patterns with reduced confidence. Machine learning models are periodically retrained using accumulated feedback data, where user confirmations serve as positive training examples and user corrections or rejections serve as negative training examples, enabling models to improve accuracy over time. Statistical analysis of feedback patterns identifies systematic issues such as specific merchants whose receipts consistently produce poor OCR results or specific geographic regions where GPS accuracy is degraded, informing targeted improvements.

An example workflow illustrating operation of the system 100 in accordance with one embodiment will now be described. A user employs the client device 102 to capture an image of a retail receipt showing a promotional discount. The client device 102 collects metadata including GPS coordinates with a stated accuracy radius of fifteen meters, a capture timestamp, a submission timestamp approximately thirty seconds after capture, a non-persistent device identifier, and image orientation information. The data ingestion module 110 receives an input data packet comprising the receipt image and associated metadata. The metadata extraction module 120 parses the metadata and assigns confidence scores to individual metadata attributes, determining that location accuracy is moderate due to the fifteen-meter accuracy radius, temporal consistency is high due to the short delay between capture and submission, and device identification is present and valid.

The image authenticity module 130 computes an image signature of the submitted image and compares it against a database of previously submitted images. No near-duplicates are identified, resulting in a high reuse detection confidence score. The freshness evaluation component 134 confirms that the short time difference between capture and input data is consistent with genuine new captures, resulting in a high freshness confidence score. The geo-temporal validation module 140 retrieves known locations of retail stores associated with the merchant identified from the receipt. The proximity calculator 144 determines that the reported GPS location is within fifty meters of a known store location, which is within acceptable proximity considering the stated fifteen-meter accuracy radius and potential indoor positioning degradation. The text extraction module 150 processes the receipt image using multiple text extraction engines and extracts text including the merchant name, purchase date, itemized product information, original prices, discounted prices, and total amount. The structural consistency checker 164 validates that discount arithmetic is consistent, thereby confirming that the stated discount percentages correctly correspond to the differences between original and discounted prices. The behavioral and market plausibility module 170 compares the extracted prices against historical price data and determines that the prices fall within expected ranges for the identified products and merchant. The composite confidence scoring engine 180 aggregates the individual confidence scores using weighted linear aggregation, producing a high overall composite confidence score. The orchestration engine 190 evaluates trigger conditions and determines that the high composite confidence score does not warrant invocation of advanced processing modules.

The user interface module 200 presents the extracted and validated information to the user via a graphical interface on the client device 102, displaying a visual indicator showing high confidence in the validation results. The user reviews the extracted information, confirms its accuracy, and submits final confirmation, which is logged for future system improvement.

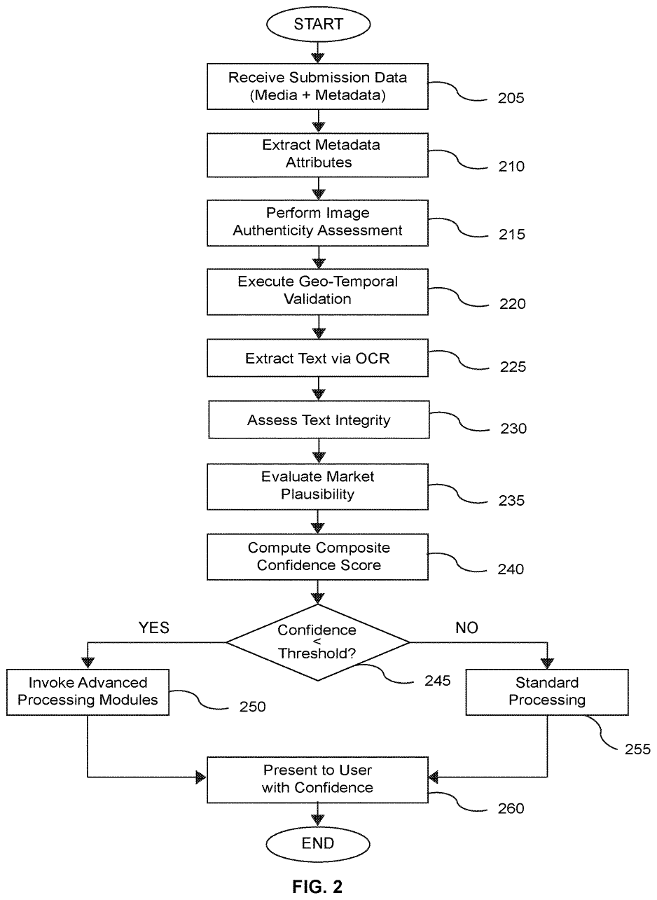

FIG. 2 illustrates a method for validating user-submitted transaction data through multi-dimensional verification with adaptive confidence scoring embodiment of the present invention. At step 205, the method begins with receiving, at a data processing system, input data comprising at least one media file and associated metadata. The input data is transmitted from a client device via a network to a data ingestion module. The media file may comprise an image of a receipt, price tag, promotional material, or other transaction-related document captured using an image sensor on the client device. The media file may be in JPEG, PNG, HEIF, WebP, or other suitable image formats.

The associated metadata comprises location data including latitude and longitude coordinates and an accuracy radius indicating the uncertainty of the position measurement. The metadata further comprises timestamp data including a capture timestamp indicating when the media file was created and a submission timestamp indicating when the submission data was transmitted. The metadata may additionally comprise device identifier data, image capture attributes such as orientation and resolution, and network context data.

At step 210, the method extracts metadata attributes from the input data. A metadata parser extracts metadata from various sources including EXIF data embedded in the image file, JSON-formatted metadata transmitted alongside the media file, or other metadata formats. The extracted metadata attributes are validated through multiple validation checks. Range validation ensures that latitude values fall within the range of negative ninety to positive ninety degrees and longitude values fall within the range of negative one hundred eighty to positive one hundred eighty degrees. Temporal validation ensures that the capture timestamp is not in the future and that the capture timestamp precedes the submission timestamp. Cross-field validation identifies inconsistencies among related metadata attributes. Confidence scores are assigned to individual metadata attributes based on their availability, consistency, and plausibility. A metadata confidence score is computed based on the quality and consistency of the extracted metadata.

At step 215, the method performs image authenticity assessment on the submitted media file. This step comprises two sub-processes: reuse detection and freshness evaluation. For reuse detection, the method computes an image signature or fingerprint of the submitted image. The image signature generates a compact representation of the image that captures perceptual similarity while being robust to minor modifications such as compression, resizing, or color adjustments. The computed image signature is compared against a database of previously submitted images using efficient similarity matching algorithms to efficiently identify similar images. In one aspect, near-duplicates are detected based on similarity measures. If a near-duplicate is identified, particularly if it was submitted by a different user, this indicates potential fraudulent reuse of images. A reuse detection confidence score is generated based on whether near-duplicates are found.

For freshness evaluation, the method compares the capture timestamp against the submission timestamp to compute a time difference. In one aspect, time-decay confidence models are applied wherein confidence decreases as the time difference increases. Further, a freshness confidence score is generated based on the time difference. The reuse detection confidence score and freshness confidence score are aggregated to generate an overall authenticity confidence score for the submission.

At step 220, the method executes geo-temporal validation logic based on the location data and timestamp data extracted from the metadata. In specific aspect, location accuracy is assessed by evaluating the accuracy radius provided in the metadata. In certain embodiments, statistical filtering algorithms (such as statistical filtering) are applied to improve location estimates based on multiple position measurements over time. Further, proximity is calculated between the reported location and known store locations. The method retrieves known locations of retail stores from a geospatial database and computes distances using geographic distance calculations. Flexible distance thresholds are applied depending on context, with larger thresholds for mall environments and smaller thresholds for standalone stores. Geofencing algorithms determine whether the reported location falls within acceptable proximity to valid transaction locations. Temporal consistency is analyzed by comparing the capture timestamp against the submission timestamp to evaluate submission delay. The method also assesses whether the capture timestamp falls within deal validity windows if promotional offers are mentioned in the extracted text. Store operating hours may be considered to detect submissions ostensibly captured when stores were closed. A geo-temporal confidence score is also computed by aggregating the results of location accuracy assessment, proximity calculation, and temporal consistency analysis.

At step 225, the method extracts textual information from the submitted media file using optical character recognition. One or more text extraction engines are applied to the image to recognize and extract text. In certain embodiments, one or more text extraction engines are employed in parallel to improve extraction accuracy. Results or output data from different text extraction engines may be aggregated through voting mechanisms or confidence-weighted selection. The raw extracted text output data comprises recognized text along with confidence scores indicating the text extraction engine's certainty about each recognized word or character.

At step 230, the method assesses the integrity of the extracted textual information. The raw extracted text output data is parsed to extract structured fields including merchant names, product descriptions, prices, dates, and promotional offer details. Natural language processing (NLP) algorithms and regular expression matching are employed to identify and extract relevant information. Further, structural consistency is validated by checking price format consistency, currency symbol placement according to locale-specific conventions, and discount arithmetic consistency. The method verifies that calculated discounts match stated percentages or amounts by comparing original prices, discount values, and final prices.

If the user interface enables users to edit extracted text, user edits are tracked by logging original extracted text output and user-corrected values. The magnitude of user modifications influences confidence scoring. In some specific aspects, a text integrity confidence score is computed based on text extraction quality, structural consistency validation results, and the extent of user edits.

At step 235, the method evaluates behavioral and market plausibility signals by comparing extracted pricing information against historical patterns and market norms. The submitted prices are compared against historical price data maintained in a database. The database stores historical price information for products, product categories, merchants, and geographic regions. In some aspects, statistical measures are computed from the historical data including mean prices, median prices, and price ranges. Temporal variations are accounted for by considering whether the submission falls within known promotional periods. In some aspects, geographic variations are accounted for by comparing against region-specific pricing data. Further, outlier detection algorithms are applied to identify input data that represent significant deviations from expected pricing patterns. Statistical techniques such as statistical outlier detection algorithms (such as Gaussian mixture models, isolation forests, or support vector machines) may also be employed. In this step, cross-validation with peer submissions is also performed by comparing the submitted prices against prices submitted by other users for similar products at similar locations and times. Finally, a market plausibility confidence score is generated based on how well the submitted pricing aligns with historical patterns and peer submissions.

At step 240, the method computes a composite confidence score by aggregating the confidence scores from multiple verification dimensions. The component confidence scores include the metadata confidence score, the authenticity confidence score, the geo-temporal confidence score, the text integrity confidence score, and the market plausibility confidence score. According to various aspects, aggregation may be performed using various approaches. In one embodiment, rule-based aggregation applies predefined rules to combine the component scores. In another embodiment, weighted scoring assigns different weights to different verification dimensions based on their relative importance, and computes a weighted average or weighted sum. In yet another embodiment, probabilistic aggregation employs probabilistic models (such as Bayesian networks) to compute posterior probabilities based on the component confidence scores. In still another embodiment, learned models trained on historical validation data using machine learning algorithms compute the composite confidence score. Such models may comprise machine learning models (such as neural networks or gradient boosted decision trees) algorithms. The composite confidence score may be expressed as a numerical value in a range from zero to one, or as a categorical label such as very high confidence, high confidence, medium confidence, low confidence, or very low confidence.

At step 245, the method evaluates trigger conditions to determine whether to invoke advanced processing modules. Trigger conditions include the composite confidence score falling below a predetermined threshold, detection of conflicting signals among different verification dimensions, identification of high-impact data such as unusually large monetary amounts or discount percentages, or specific patterns or anomalies flagged by individual verification modules. If one or more trigger conditions are satisfied, the method selectively invokes 250 advanced processing modules. Advanced processing may include deep learning-based image analysis to detect sophisticated image manipulations, natural language understanding for semantic analysis of extracted text, reasoning-based interpretation using large language models or expert systems, fraud pattern recognition using trained classifiers, or cross-reference validation against external authoritative data sources. In some aspects, cost-awareness mechanisms track the computational or financial costs associated with different advanced processing modules and make invocation decisions that balance validation accuracy against processing costs. Results or output data from advanced processing modules may be used to update the composite confidence score or to provide additional validation signals that inform the final validation decision. If trigger conditions are not satisfied, the method performs standard processing 255.

At step 260, the method presents the validated data with confidence indicators to a user interface. The extracted and validated information is displayed to the user via a graphical user interface on the client device or via a web interface. In some embodiments, confidence indicators are displayed alongside the extracted information, informing the user of the system's confidence in the validation results. Visual indicators may include color-coded confidence levels, numerical confidence scores, or textual messages such as ‘high confidence’ or ‘please review carefully’. The user interface enables the user to perform actions including confirming that the extracted information is accurate, correcting errors in the extracted text or structured fields, overriding system determinations with user-provided explanations, or providing additional context. User interactions are logged, recording submission identifiers, user identifiers, timestamps, details of user edits or corrections, and validation outcomes. The logged user feedback is used to improve future validation and scoring through validation parameter adjustment mechanisms and periodic retraining of machine learning models.

In accordance with another aspect of the present invention, there is provided a non-transitory computer-readable storage medium storing executable instructions that, when executed by one or more processors, cause the one or more processors to perform the method for multi-dimensional verification of user-submitted transaction data as described above.

The non-transitory computer-readable storage medium may be embodied as any suitable storage technology including magnetic storage media such as hard disk drives, solid-state storage media such as solid-state drives or flash memory, optical storage media such as CD-ROM or DVD-ROM, or other persistent storage technologies. The term ‘non-transitory’ excludes transitory propagating signals but includes all forms of persistent computer-readable storage media. The computer-readable medium stores executable instructions organized into functional modules corresponding to the steps of the method embodiment and the components of the system embodiment. The medium stores data reception instructions that, when executed by the one or more processors, cause the processors to receive submission data comprising at least one media file and associated metadata. The data reception instructions implement network communication protocols to receive data transmitted from a client device, validate the format and structure of the received data, and store the media file and metadata for subsequent processing.

The medium stores metadata extraction instructions that, when executed, cause the processors to extract metadata attributes from the submission data. The metadata extraction instructions implement parsing algorithms to extract metadata from EXIF data embedded in image files, JSON-formatted metadata, or other metadata formats. The metadata extraction instructions further implement validation logic to perform range validation on coordinate values, temporal validation on timestamps, and cross-field validation to identify inconsistencies. The instructions implement confidence scoring algorithms to assign confidence values to individual metadata attributes. The medium stores image authenticity assessment instructions that, when executed, cause the processors to perform reuse detection and freshness evaluation on submitted images. The reuse detection instructions implement image signature algorithms to generate compact image representations, efficient similarity matching algorithms to efficiently search for similar images in large databases, and similarity comparison logic to detect near-duplicates. The freshness evaluation instructions implement logic to compare capture timestamps against submission timestamps, apply time-decay confidence models, and generate freshness confidence scores. The image authenticity assessment instructions further implement aggregation logic to combine reuse detection and freshness evaluation results into an overall authenticity confidence score.

The medium stores geo-temporal validation instructions that, when executed, cause the processors to assess location accuracy, calculate proximity to known store locations, and analyze temporal consistency. The location accuracy assessment instructions may implement statistical filtering algorithms (such as statistical filtering) to improve location estimates based on multiple position measurements. The proximity calculation instructions implement geographic distance computations to calculate distances between reported locations and known store locations. The instructions implement geofencing algorithms to determine whether reported locations fall within acceptable proximity to valid transaction locations, applying context-dependent distance thresholds. The temporal consistency analysis instructions implement logic to evaluate submission delays, assess deal validity windows, and detect temporal anomalies.

The geo-temporal validation instructions further implement aggregation logic to compute a geo-temporal confidence score from the location and temporal validation results. The medium stores text extraction instructions that, when executed, cause the processors to apply one or more optical character recognition engines to the submitted media file. The text extraction instructions may invoke OCR libraries or APIs including text extraction engines, cloud-based text extraction services, or other OCR technologies. In embodiments employing multiple text extraction engines, the text extraction instructions implement parallel processing logic to invoke multiple engines simultaneously and aggregation logic to combine results from different engines.

The medium stores text integrity assessment instructions that, when executed, cause the processors to parse raw extracted text output, extract structured fields, and validate structural consistency. The text parsing instructions implement natural language processing algorithms and regular expression matching to identify and extract merchant names, product descriptions, prices, dates, and promotional offer details from the raw extracted text output. The structural consistency checking instructions implement validation logic to verify price format consistency, currency symbol placement, and discount arithmetic. The instructions compute expected values based on stated percentages or amounts and compare against extracted values to detect inconsistencies. The text integrity assessment instructions further implement edit tracking logic to log user corrections if the user interface enables text editing, and confidence scoring logic to compute text integrity confidence scores.

The medium stores market plausibility evaluation instructions that, when executed, cause the processors to compare extracted pricing information against historical price data. The instructions implement database query logic to retrieve historical price information for relevant products, merchants, and geographic regions. Statistical analysis logic computes measures such as mean prices, median prices, and price ranges from the historical data. The market plausibility evaluation instructions implement outlier detection algorithms such as statistical outlier detection algorithms (such as Gaussian mixture models, isolation forests, or support vector machines) to identify submissions that deviate significantly from expected patterns. The instructions further implement cross-validation logic to compare submitted prices against peer submissions and confidence scoring logic to generate market plausibility confidence scores. The medium stores composite confidence scoring instructions that, when executed, causes the processors to aggregate confidence scores from multiple verification dimensions. The aggregation instructions may implement rule-based logic applying predefined rules, weighted scoring logic computing weighted averages or weighted sums, probabilistic aggregation logic employing Bayesian networks, or learned model logic invoking trained machine learning models to compute composite confidence scores.

The medium stores conditional processing orchestration instructions that, when executed, cause the processors to evaluate trigger conditions and selectively invoke advanced processing modules. The trigger evaluation instructions implement logic to compare the composite confidence score against predetermined thresholds, detect conflicting signals among verification dimensions, identify high-impact data, and recognize specific anomaly patterns. The advanced processing invocation instructions implement logic to selectively invoke deep learning-based image analysis modules, natural language understanding modules, reasoning-based interpretation modules, fraud pattern recognition modules, or external data cross-reference modules based on the trigger conditions. The orchestration instructions further implement cost-awareness logic to track and consider computational costs or API invocation costs when making invocation decisions.

The medium stores user interface presentation instructions that, when executed, cause the processors to generate user interface displays presenting validated data with confidence indicators. The presentation instructions implement logic to format extracted information for display, generate visual confidence indicators such as color-coded elements or numerical scores, and render graphical user interface elements on the client device or via a web interface. The user interface instructions further implement interaction handling logic to receive user actions such as confirmations, corrections, overrides, or additional context provision. Feedback logging instructions implement logic to record user interactions including timestamps, user edits, and validation outcomes. The logged feedback is stored for use in Adaptive learning processes and model retraining processes that improve future validation accuracy.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims. The specification discloses exemplary embodiments that demonstrate different aspects of the invention. The invention is not limited to these exemplary embodiments. Many variations and modifications will be apparent to those of ordinary skill in the art upon review of this disclosure. The scope of the invention should be determined not with reference to the above description, but instead should be determined with reference to the claims along with their full scope of equivalents.

1. A method for validating user-submitted transaction data, the method comprising:
receiving, at a data processing system, input data comprising at least one media file and associated metadata;
extracting, by a metadata extraction module, metadata attributes from the input data, wherein the metadata attributes comprise at least location data, timestamp data, and device identifier data;
performing, by an image authenticity module, image authenticity assessment on the at least one media file, wherein the image authenticity assessment comprises:
similarity analysis to detect reuse across multiple submissions; and
temporal freshness evaluation based on timestamp data;
executing, by a geo-temporal validation module, geo-temporal validation logic based on the location data and the timestamp data, wherein the geo-temporal validation logic comprises:
assessing location accuracy of the location data;
calculating proximity between the location data and known transaction locations; and
analyzing temporal consistency between an image capture time metadata and image submission timestamp data;
extracting, by a text extraction module, textual information from the at least one media file;
performing, by a text integrity assessment module, integrity assessment of the extracted textual information;
evaluating, by a behavioral and market plausibility module, behavioral and market plausibility signals by comparing the extracted textual information against historical price data;
computing, by a composite confidence scoring engine, a composite confidence score based on aggregating confidence values from the metadata extraction module, the image authenticity module, the geo-temporal validation module, the text integrity assessment module, and the behavioral and market plausibility module;
conditionally invoking, by an orchestration engine, at least one advanced processing module based on evaluation of the composite confidence score and trigger conditions; and
presenting, via a user interface module, validated data with confidence indicators to enable user confirmation or correction and logging user interactions for validation parameter adjustment.

2. The method of claim 1, wherein the metadata attributes comprise location data with latitude and longitude coordinates and accuracy radius, capture timestamp, submission timestamp, device identifier, image orientation, image resolution, and network context data.

3. The method of claim 1, wherein the similarity analysis comprises:
computing an image signature using image similarity algorithms including at least one of perceptual hashing, feature extraction, or fingerprinting techniques;
comparing the image signature against a database of previously submitted images using efficient similarity matching algorithms; and
detecting near-duplicate images based on similarity thresholds.

4. The method of claim 3, wherein the efficient similarity matching algorithms comprise locality-sensitive hashing (LSH) algorithms.

5. The method of claim 1, wherein the temporal freshness evaluation further comprises applying time-decay confidence models wherein confidence decreases as time difference between the capture time metadata and the received time metadata increases.

6. The method of claim 1, wherein the assessing location accuracy comprises applying statistical filtering algorithms to improve location estimates based on the location data and historical location patterns.

7. The method of claim 6, wherein the statistical filtering algorithms comprise at least one of Kalman filtering algorithms or particle filtering algorithms.

8. The method of claim 1, wherein the text extraction module implements optical character recognition (OCR) techniques to extract the textual information.

9. The method of claim 8, wherein the extracting textual information comprises:
applying multiple text extraction engines in parallel to the at least one media file; and
aggregating results from the multiple text extraction engines using voting mechanisms or confidence-weighted selection.

10. The method of claim 1, wherein performing integrity assessment comprises:
parsing the extracted textual information to identify structured fields including prices, dates, and merchant identifiers;
validating structural consistency of the structured fields including price format and arithmetic consistency; and
tracking user edits to the extracted textual information.

11. The method of claim 1, wherein evaluating behavioral and market plausibility signals comprises:
comparing extracted pricing information against historical price data for products, merchants, and geographic regions;
computing statistical measures from the historical price data; and
applying statistical outlier detection to identify significant deviations from expected pricing patterns.

12. The method of claim 1, wherein the statistical outlier detection comprises at least one of Gaussian mixture models, isolation forests, or one-class support vector machines.

13. The method of claim 1, wherein computing the composite confidence score comprises at least one of:
rule-based aggregation using predefined rules;
weighted scoring with predetermined weights assigned to different verification dimensions;
probabilistic aggregation; or
learned model aggregation trained on historical validation data.

14. The method of claim 13, wherein the probabilistic aggregation employs Bayesian networks.

15. The method of claim 13, wherein the learned model aggregation employs neural networks.

16. The method of claim 1, wherein the computing a composite confidence score comprises implementing weighted linear aggregation.

17. The method of claim 1, wherein the at least one advanced processing module comprises at least one of:
deep learning-based image analysis;
natural language understanding for semantic analysis;
reasoning-based interpretation; or
fraud pattern recognition.

18. The method of claim 1, wherein logging user interactions for validation parameter adjustment comprises:
recording user confirmations, corrections, and overrides;
analyzing patterns in user feedback; and
updating validation parameters based on the analyzed patterns.

19. A system for validating user-submitted transaction data, the system comprising:
a data ingestion module configured to receive input data comprising at least one media file and associated metadata from a client device;
a metadata extraction module operatively coupled to the data ingestion module and configured to extract metadata attributes including at least location data and timestamp data;
an image authenticity module configured to perform image authenticity assessment comprising:
similarity analysis to detect reuse across submissions; and
temporal freshness evaluation based on the timestamp data;
a geo-temporal validation module configured to execute validation logic comprising:
location accuracy assessment;
proximity calculation to known transaction locations; and
temporal consistency analysis;
a text extraction module configured to extract textual information from the at least one media file;
a text integrity assessment module configured to assess integrity of the extracted textual information;
a behavioral and market plausibility module configured to evaluate plausibility signals by comparing the extracted textual information against historical transaction data;
a composite confidence scoring engine configured to compute a composite confidence score by aggregating confidence values from multiple verification modules;
an orchestration engine configured to conditionally invoke advanced processing modules based on the composite confidence score and trigger conditions; and
a user interface module configured to present validated data with confidence indicators and log user interactions for validation parameter adjustment.

20. A non-transitory computer-readable storage medium storing instructions that, when executed by one or more processors, cause the one or more processors to perform operations comprising:
receiving, at a data processing system, input data comprising at least one media file and associated metadata;
extracting, by a metadata extraction module, metadata attributes from the input data, wherein the metadata attributes comprise at least location data, timestamp data, and device identifier data;
performing, by an image authenticity module, image authenticity assessment on the at least one media file, wherein the image authenticity assessment comprises:
similarity analysis to detect reuse across multiple submissions; and
temporal freshness evaluation based on timestamp data;
executing, by a geo-temporal validation module, geo-temporal validation logic based on the location data and the timestamp data, wherein the geo-temporal validation logic comprises:
assessing location accuracy of the location data;
calculating proximity between the location data and known transaction locations; and
analyzing temporal consistency between an image capture time metadata and image submission timestamp data;
extracting, by a text extraction module, textual information from the at least one media file;
performing, by a text integrity assessment module, integrity assessment of the extracted textual information;
evaluating, by a behavioral and market plausibility module, behavioral and market plausibility signals by comparing the extracted textual information against historical price data;
computing, by a composite confidence scoring engine, a composite confidence score based on aggregating confidence values from the metadata extraction module, the image authenticity module, the geo-temporal validation module, the text integrity assessment module, and the behavioral and market plausibility module;
conditionally invoking, by an orchestration engine, at least one advanced processing module based on evaluation of the composite confidence score and trigger conditions; and
presenting, via a user interface module, validated data with confidence indicators to enable user confirmation or correction and logging user interactions for validation parameter adjustment.
